(19) United States
(12) Patent Application Publication
(10) Pub. No.: US 2016/0198029 A1
(43) Pub. Date: Jul. 7, 2016

(54) ELECTRONIC DEVICE ASSEMBLY

(71) Applicants: HONG FU JIN PRECISION INDUSTRY (WUHAN) CO., LTD., Wuhan (CN); HON HAI PRECISION INDUSTRY CO., LTD., New Taipei (TW)

(72) Inventors: LI-XIN LIU, Wuhan (CN); QUAN-GUANG DU, Wuhan (CN); WEI-KUANG LIANG, New Taipei (TW)

(21) Appl. No.: 14/603,575

(22) Filed: Jan. 23, 2015

(30) Foreign Application Priority Data
Jan. 7, 2015 (CN) 201510006209.3

(51) Int. Cl. H04M 1/02

(52) U.S. Cl. CPC H04M 1/0254; H04M 1/0249; H04M 1/0206

(57) ABSTRACT

Electronic device assembly includes a first electronic device, a second electronic device; and a coupling device coupled to the first electronic device and the second electronic device. The coupling device includes at least two segments moveably attached to each other. The first electronic device is rotatable relative to the second electronic device to be located in a first position, where the first electronic device is slanted relative to the second electronic device, and the at least two segments are moveable to position the first electronic device in a second position, where the first electronic device is substantially parallel to the second electronic device.

### FIELD

The subject matter herein generally relates to an electronic device assembly which includes a first electronic device and a second electronic device.

### BACKGROUND

Popular electronic devices, such as tablet computers, personal digital assistants, or smart phones, can be used to connect a peripheral device, such as a keyboard, to play music and games and to view pictures.

### BRIEF DESCRIPTION OF THE DRAWINGS

Implementations of the present technology will now be described, by way of example only, with reference to the attached figures, wherein:

FIG. 1 is an exploded, isometric view of an embodiment of an electronic device assembly.

FIG. 2 is an assembled view of a rear plate of a first electronic device and a clamping member of a coupling device of the electronic device assembly of FIG. 1.

FIG. 3 is an enlarged view of a circled portion III of FIG. 2.

FIG. 4 is an isometric view of the coupling device of the electronic device assembly of FIG. 1.

FIG. 5 is a partial, assembled view of the rear plate and the coupling device of the electronic device assembly of FIG. 1.

FIG. 6 is a first assembled view of the electronic device assembly of FIG. 1, and a display of the first electronic device is face to face with a second electronic device.

FIG. 7 is similar to FIG. 6, and the display of the first electronic device is back to back with the second electronic device.

FIG. 8 is a second assembled view of the electronic device assembly of FIG. 1, and the first electronic device is parallel to the second electronic device.

FIG. 9 is similar to FIG. 8, and the first electronic device is separated from the second electronic device.

### DETAILED DESCRIPTION

It will be appreciated that for simplicity and clarity of illustration, where appropriate, reference numerals have been repeated among the different figures to indicate corresponding or analogous elements. In addition, numerous specific details are set forth in order to provide a thorough understanding of the embodiments described herein.

However, it will be understood by those of ordinary skill in the art that the embodiments described herein can be practiced without these specific details. In other instances, methods, procedures and components have not been described in detail so as not to obscure the related relevant feature being described. Also, the description is not to be considered as limiting the scope of the embodiments described herein. The drawings are not necessarily to scale and the proportions of certain parts may be exaggerated to better illustrate details and features of the present disclosure.

Several definitions that apply throughout this disclosure will now be presented.

The term “coupled” is defined as connected, whether directly or indirectly through intervening components, and is not necessarily limited to physical connections. The connection can be such that the objects are permanently connected or releasably connected. The term “outside” refers to a region that is beyond the outermost confines of a physical object. The term “substantially” is defined to be essentially conforming to the particular dimension, shape or other word that substantially modifies, such that the component need not be exact. For example, substantially cylindrical means that the object resembles a cylinder, but can have one or more deviations from a true cylinder. The term “comprising,” when utilized, means “including, but not necessarily limited to”; it specifically indicates open-ended inclusion or membership in the so-described combination, group, series and the like.

The present disclosure is described in relation to an electronic device assembly. The electronic device assembly includes a first electronic device, a second electronic device; and a coupling device coupled to the first electronic device and the second electronic device. The coupling device includes at least two segments moveably attached to each other. The first electronic device is rotatable relative to the second electronic device to a first position, where the first electronic device is slanted relative to the second electronic device, and the at least two segments are moveable to position the first electronic device in a second position, where the first electronic device is substantially parallel to the second electronic device.

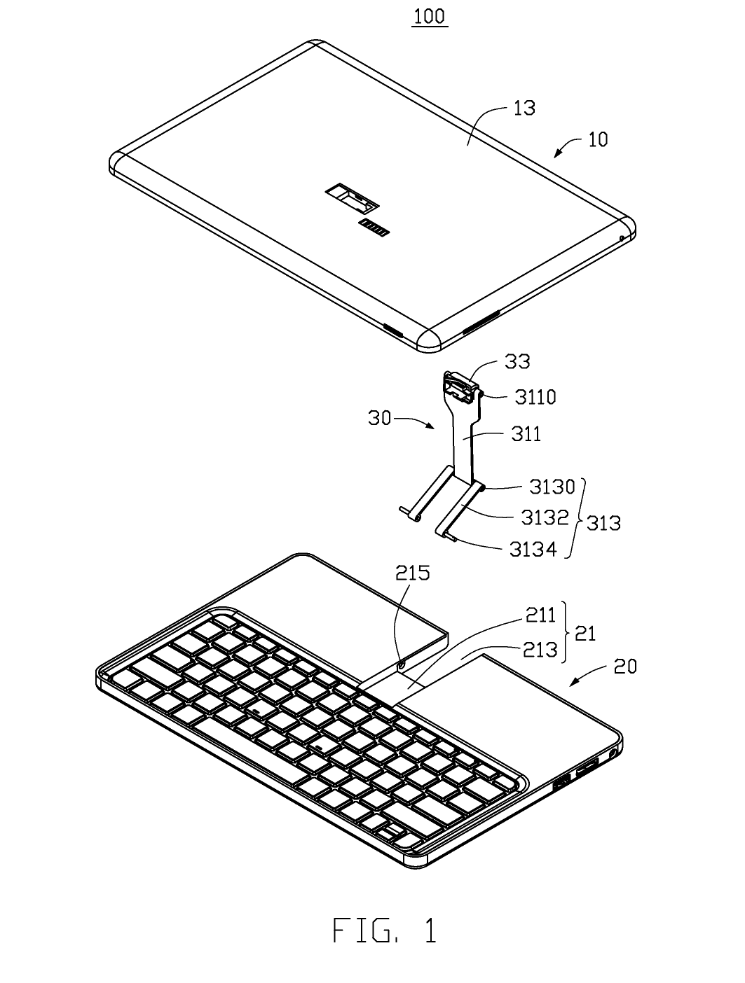

FIG. 1 illustrates an embodiment of an electronic device assembly 100. The electronic device assembly 100 includes a first electronic device 10, a second electronic device 20 configured to be engaged with the first electronic device 10, and a coupling device 30 movably engaged with the first electronic device 10 and the second electronic device 20. In at least one embodiment, the first electronic device 10 can be a portable device, such as a tablet computer, a personal digital assistant, or a smart phone. The second electronic device 20 can be a peripheral device, such as a power supply or a keyboard.

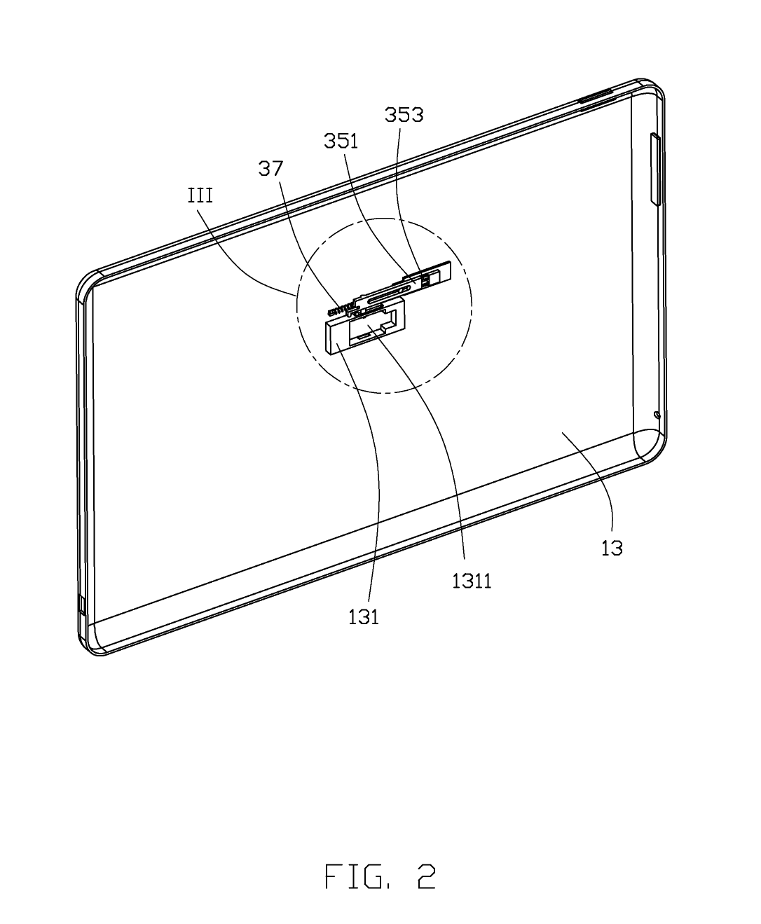

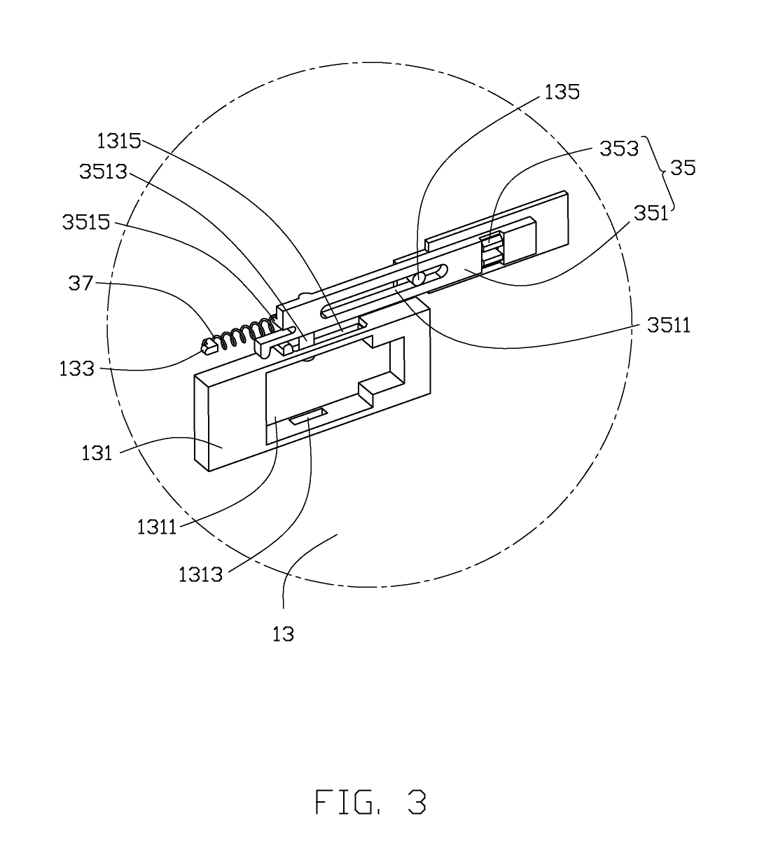

FIGS. 2 and 3 illustrate an embodiment of the first electronic device 10 and the second electronic device 20 of the electronic device assembly 100. The first electronic device 10 includes a display 11 and a rear plate 13 opposite to the display 11. The rear plate 13 includes a mounting portion 131, a mounting post 133 and a protruding post 135. The mounting post 133 and the protruding post 135 are located above the mounting portion 131. The mounting portion 131 defines a mounting hole 1311, a clipping slot 1313 and a receiving slot 1315. The clipping slot 1313 and the receiving slot 1315 are located at opposite ends of the mounting hole 1311 and communicate with the mounting hole 1311.

The second electronic device 20 includes a receiving portion 21. The receiving portion 21 includes a first portion 211 and a second portion 213 below the first portion 211. In at least one embodiment, the second portion 213 is a cutout and communicates with the first portion 211. A receiving hole 215 is defined in each of two parallel sides of the second portion 213 and located in the first portion 211.

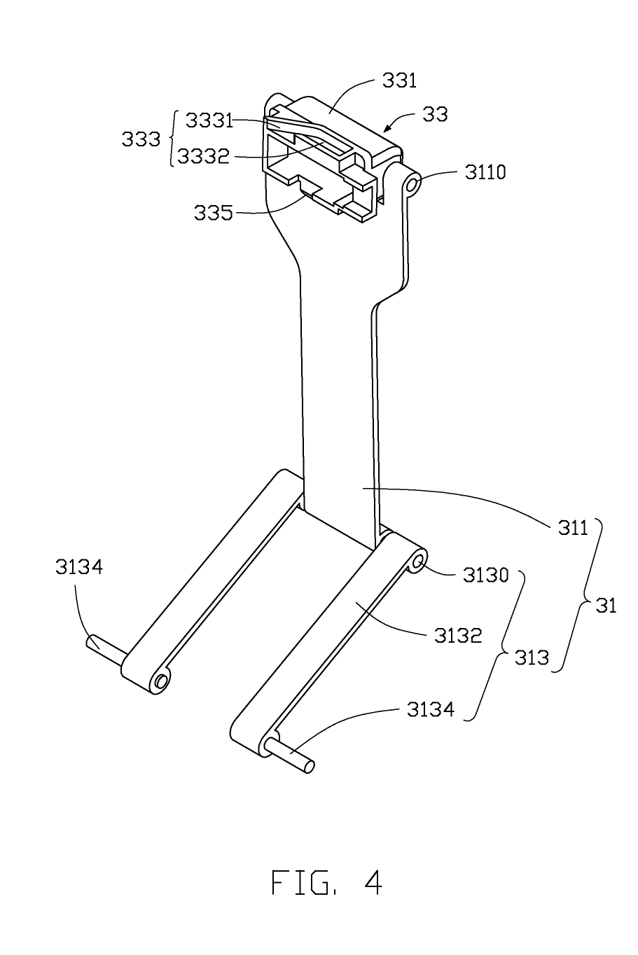

FIGS. 3-5 illustrate an embodiment of the coupling device 30 of the electronic device assembly 100. The coupling device 30 includes a coupling assembly 31, a securing member 33, a clamping member 35, and an elastic member 37. The coupling assembly 31 includes at least two segments moveably connected to each other, and the at least two segments can be moveable to allow the first electronic device 10 to rotate relative to the second electronic device 20. In at least one embodiment, the coupling assembly 31 includes a first segment 311 and a second segment 313 rotatably coupled to the first segment 311. The first segment 311 includes a first coupling shaft 3110 rotatably coupled to the securing member 3110. The second segment 313 includes a second coupling shaft 3130, two parallel coupling poles 3132, and a rotating shaft 3134 coupled to each coupling pole 3132. The second coupling shaft 3130 is rotatably coupled to the first segment 311, and the rotating shaft 3134 can be rotatably received in the receiving hole 215.

The securing member 33 is rotatably attached to the first coupling shaft 3110 and includes a main body 331, a sliding slot 333 defined in the main body 331, and a securing piece 335 extending from the main body 331. The sliding slot 333 includes a first sliding portion 3331 and a second sliding portion 3332 communicating with the first sliding portion 3331. The second sliding portion 3332 is slanted relative to the first sliding portion 3331.

The clamping member 35 includes a clamping body 351 and an operating portion 353 engaged with the clamping body 351. A sliding hole 3511 is defined in the clamping body 351 and is configured for receiving the protruding post 135. The clamping body 351 includes a clamping portion 3513 and a hook 3515. The clamping portion 3513 can extend through the receiving slot 1315 to be slidably received in the sliding slot 333. The operating portion 353 extends through the rear plate 13 and is located outside of the rear plate 13. The operating portion 353 can be operated to slide the clamping body 351 in a first direction that is substantially parallel to the rear plate 13, and the clamping portion 3513 is simultaneously slid in the sliding slot 333.

A first end of the elastic member 37 can be engaged with the mounting post 133; a second end of the elastic member 37 can be engaged with the hook 3515. The elastic member 37 can be deformed when the clamping body 351 is sliding in the first direction and can be released to slide the clamping body 351 in a second direction that is opposite to the first direction.

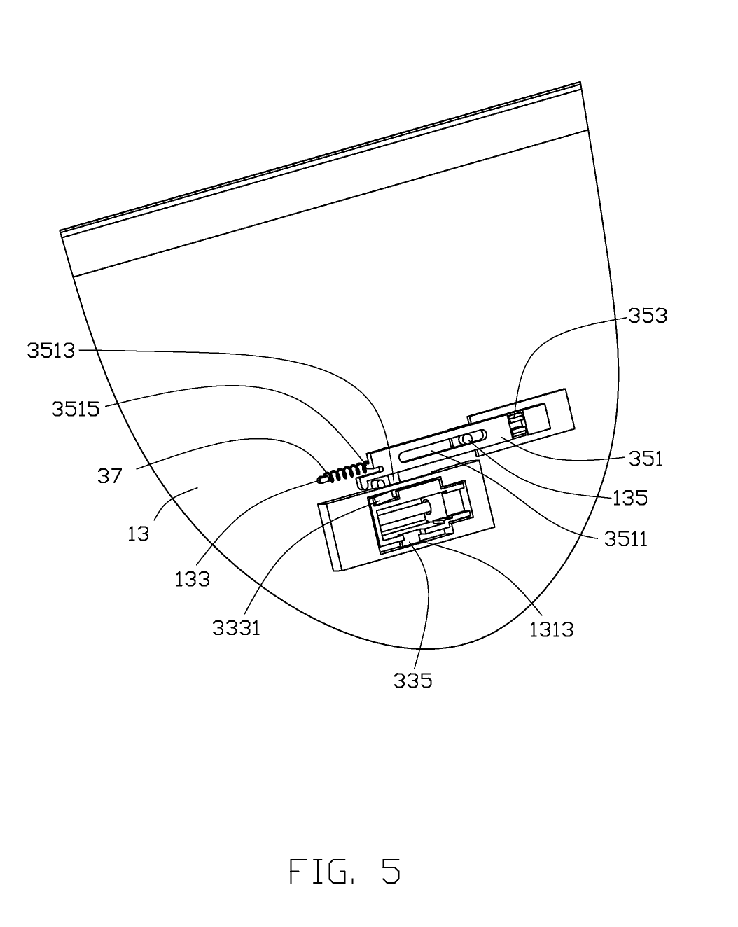

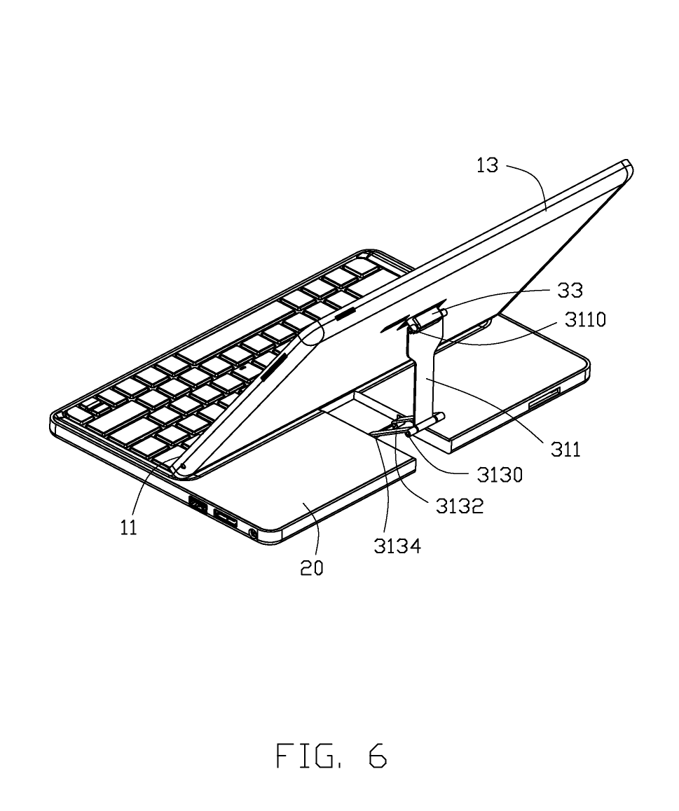

FIGS. 5 and 6 illustrate an assembled view of the electronic device assembly 100. In assembly, each rotating shaft 3134 is rotatably received in the receiving hole 215 to secure the first segment 313 to the second electronic device 20. The securing member 33 is located on the outside of the rear plate 13 and extends through the mounting hole 1311, and the securing piece 335 is engaged in the clipping slot 131. The clamping portion 3513 extends through the receiving slot 1315 to be slidably received in the sliding slot 333, and the protruding post 135 is received in the sliding hole 3511. The operating portion 353 extends though the rear plate 13 to engage with the clamping body 351. The first end of the elastic member 37 is engaged with the mounting post 133; a second end of the elastic member 37 is engaged with the hook 3515. Therefore, the electronic device assembly 100 is assembled.

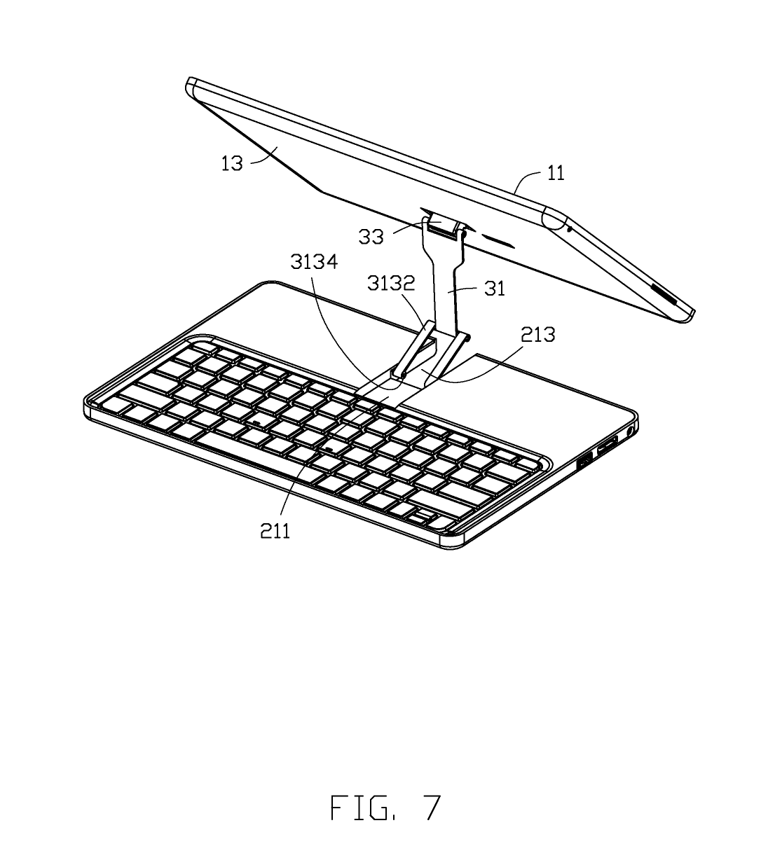

FIGS. 6 and 7 illustrate the electronic device assembly 100 in a first position. In use, the second segment 313 is rotated about the rotating shaft 3134, and the first segment 311 is rotated about the second coupling shaft 3130. The first electronic device 10 is rotated about the first coupling shaft 3110, so that the first electronic device 10 can be rotated relative to the second electronic device 20 to the first position. When the first electronic device 10 is in the first position, the first electronic device 10 is slanted relative to the second electronic device 20. In at least one embodiment, the display 11 can be face to face with the second electronic device 20 (see FIG. 6), the display 11 can be also back to back with the second electronic device 20 (see FIG. 7), and the display 11 can be also perpendicular to the second electronic device 20 (not shown).

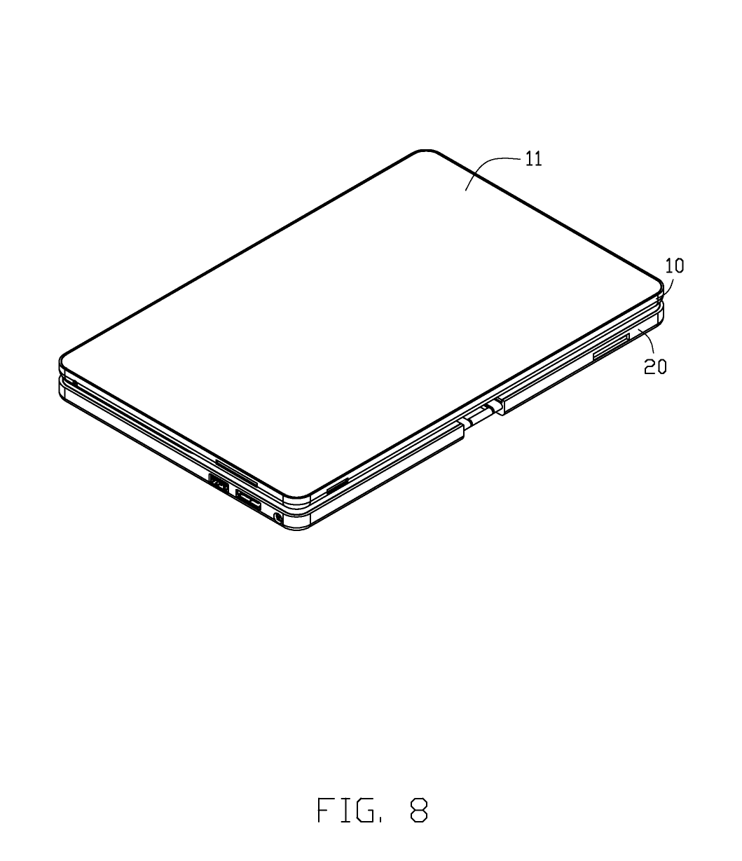

FIG. 8 illustrates the electronic device assembly 100 being located in a second position. The second segment 313 is rotated about the rotating shaft 3134 clockwise to be received in the second portion 213, and the first segment 311 is rotated about the second coupling shaft 3130 counterclockwise to be received in the first portion 211. The first electronic device 10 is rotated about the first coupling shaft 3110 to be located in the second position, where the first electronic device 10 is substantially parallel to the second electronic device 20.

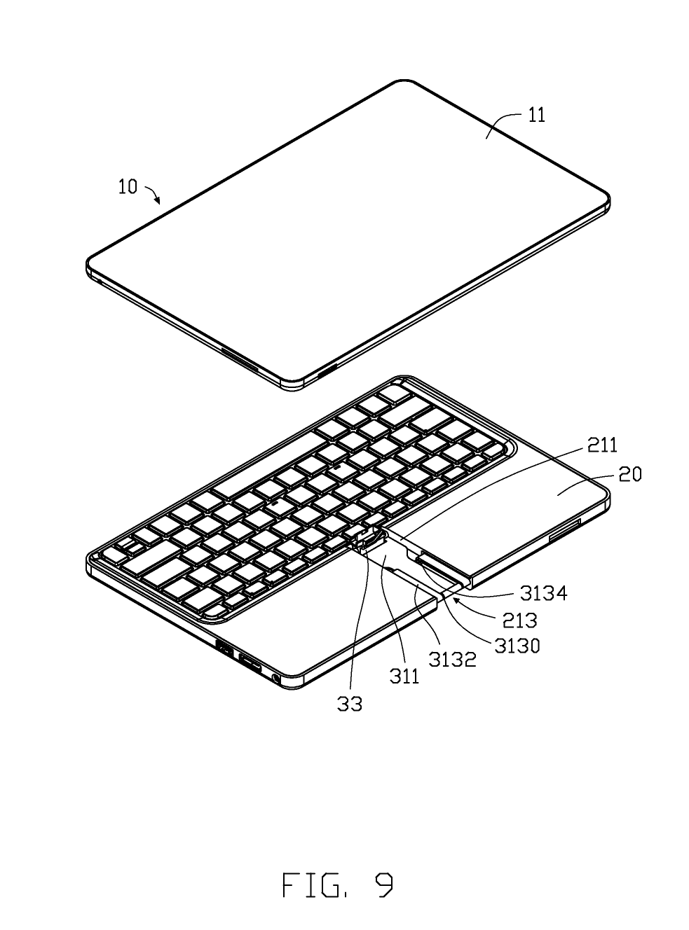

FIG. 9 illustrates the first electronic device 10 is separated from the second electronic device 20. When the first electronic device 10 needs to be separated from the second electronic device 20, the operating portion 353 is operated to move the clamping body 351 in the first direction, and the clamping portion 3513 is slid in the first sliding portion 3331 to the second sliding portion 3332. The elastic member 37 is deformed. The securing member 33 is pulled to disengage the securing piece 355 from the clipping slot 1313, and the securing member 33 can be removed from the mounting hole 1311 to allow the detachment of the securing member 33 from the rear plate 13. The elastic member 37 is released to move the clamping member 35 in the second direction. The second segment 313 is rotated about the rotating shaft 3134 clockwise to be received in the second portion 213, and the first segment 311 is rotated about the second coupling shaft 3130 counterclockwise to be received in the first portion 211. Therefore, the first electronic device 10 can be separated from the second electronic device 20 for use, and the coupling device 30 is also received in the second electronic device 20.

The embodiments shown and described above are only examples. Many details are often found in the art such as the other features of an electronic device assembly. Therefore, many such details are neither shown nor described. Even though numerous characteristics and advantages of the present technology have been set forth in the foregoing description, together with details of the structure and function of the present disclosure, the disclosure is illustrative only, and changes may be made in the detail, especially in matters of shape, size and arrangement of the parts within the principles of the present disclosure up to, and including the full extent established by the broad general meaning of the terms used in the claims. It will therefore be appreciated that the embodiments described above may be modified within the scope of the claims.

What is claimed is:

1. An electronic device assembly comprising:
a first electronic device;
a second electronic device; and
a coupling device coupled to the first electronic device and the second electronic device; the coupling device comprising at least two segments moveably attached to each other;
wherein the first electronic device is rotatable relative to the second electronic device and is positioned by the coupling device in a first position where the first electronic device is slanted relative to the second electronic device, and the at least two segments is moveable to position the first electronic device in a second position where the first electronic device is substantially parallel to the second electronic device.

2. The electronic device assembly of claim 1, wherein the at least two segments comprises a first segment and a second segment rotatably attached to the first segment, the first segment is rotatably coupled to the first electronic device, and the second segment is rotatably coupled to the second electronic device.

3. The electronic device assembly of claim 2, wherein the first segment is rotatable about a first shaft, and the second segment is rotatable a second shaft that is substantially parallel to the first shaft.

4. The electronic device assembly of claim 2, wherein the second electronic device comprises a receiving portion, the receiving portion comprises a first portion and a second portion below the first portion, when the first electronic device is located in the second position, the first segment is received in the first portion, and the second segment is received in the second portion.

5. The electronic device assembly of claim 2, wherein the coupling device further comprises a securing member coupled to the first segment and a clamping member engaged with the securing member, the securing member is secured to the first electronic device, and the clamping member is engaged with the securing member for preventing the securing from disengaging from the first electronic device.

6. The electronic device assembly of claim 5, wherein the clamping member defines a sliding hole, and the first electronic device comprises a protruding post slidably received in the sliding hole.

7. The electronic device assembly of claim 5, wherein the securing member defines a sliding slot, and the clamping member comprises a clamping portion slidably received in the sliding slot.

8. The electronic device assembly of claim 7, wherein the sliding slot comprises a first sliding portion and a second sliding portion communicating with the first sliding portion, and the second sliding portion is slanted relative to the first sliding portion.

9. The electronic device assembly of claim 7, wherein the first electronic device further comprises a rear plate, and the clamping member is slidable in a first direction that is substantially parallel to the rear plate to disengage the clamping portion from the sliding slot.

10. The electronic device assembly of claim 9, wherein the coupling device further an elastic member located between the first electronic device and the clamping member, the elastic member is deformed when the clamping member is slidable in the first direction and is released to slide the clamping member in a second direction that is substantially opposite to the first direction.

11. An electronic device assembly comprising:
a first electronic device;
a second electronic device; and
a coupling device comprising a first segment and a second segment rotatably attached to the first segment, the first segment rotatably attached to the first electronic device, and the second segment rotatably attached to the second electronic device;
wherein the first electronic device is rotatable relative to the first segment, the first segment is rotatable relative to the second segment, the second segment is rotatable relative to the second electronic device, thereby the first electronic device is rotatable relative to the second electronic device between a first position, where the first electronic device is slanted relative to the second electronic device, and a second position, where the first electronic device is substantially parallel to the second electronic device.

12. The electronic device assembly of claim 11, wherein the first segment is rotatable about a first shaft, and the second segment is rotatable a second shaft that is substantially parallel to the first shaft.

13. The electronic device assembly of claim 11, wherein the second electronic device comprises a receiving portion, the receiving portion comprises a first portion and a second portion below the first portion, when the first electronic device is located in the second position, the first segment is received in the first portion, and the second segment is received in the second portion.

14. The electronic device assembly of claim 11, wherein the coupling device further comprises a securing member coupled to the first segment and a clamping member engaged with the securing member, the securing member is secured to the first electronic device, and the clamping member is engaged with the securing member for preventing the securing from disengaging from the first electronic device.

15. The electronic device assembly of claim 14, wherein the clamping member defines a sliding hole, and the first electronic device comprises a protruding post slidably received in the sliding hole.

16. The electronic device assembly of claim 14, wherein the securing member defines a sliding slot, and the clamping member comprises a clamping portion slidably received in the sliding slot.

17. The electronic device assembly of claim 16, wherein the sliding slot comprises a first sliding portion and a second sliding portion communicating with the first sliding portion, and the second sliding portion is slanted relative to the first sliding portion.

18. The electronic device assembly of claim 16, wherein the first electronic device further comprises a rear plate, and the clamping member is slidable in a first direction that is substantially parallel to the rear plate to disengage the clamping portion from the sliding slot.

19. The electronic device assembly of claim 18, wherein the coupling device further an elastic member located between the first electronic device and the clamping member, the elastic member is deformed when the clamping member is slidable in the first direction and is released to slide the clamping member in a second direction that is substantially opposite to the first direction.
